(19) United States
(12) Patent Application Publication
(10) Pub. No.: US 2022/0212616 A1
(43) Pub. Date: Jul. 7, 2022

(54) BEAM FOR FRONT BUMPER ASSEMBLY

(71) Applicant: Shape Corp., Grand Haven, MI (US)

(72) Inventors: Andreas Krasel, Munich (DE); Stephane Anquetil, Le Chesnay (FR)

(21) Appl. No.: 17/569,300

(22) Filed: Jan. 5, 2022

Related U.S. Application Data
(60) Provisional application No. 63/133,937, filed on Jan. 5, 2021.

(51) Int. Cl. B60R 19/44; B60R 19/34

(52) U.S. Cl. CPC B60R 19/44; B60R 19/34

(57) ABSTRACT

A reinforcement beam for a vehicle bumper assembly includes a metal sheet formed into a beam having at least one tubular section extending along a length of the beam. The length of the beam has a central section disposed between end sections of the beam, such that the length of the beam spans laterally across a vehicle frame. The beam also has bend sections formed between the central section and the end sections of the beam to dispose the end sections rearward from the central section relative to the vehicle frame. The end sections of the beam terminate at distal ends an extended length outboard along the length of the beam from the pair of connection features configured to attach the beam to crush cans.

### CROSS-REFERENCE TO RELATED APPLICATION

This application claims priority under 35 U.S.C. § 119(e) to U.S. Provisional Patent Application No. 63/133,937, filed Jan. 5, 2021, the disclosure of this prior application is considered part of this application and is hereby incorporated by reference in its entirety.

### TECHNICAL FIELD

The present disclosure relates to bumper assemblies for vehicles, and more particularly to a bumper beam or a reinforcement beam spanning across a front end of a vehicle.

### BACKGROUND

When a vehicle undergoes impact from a crash at the front end of the vehicle, the vehicle's bumper assembly is designed to receive and absorb the impact energy in an effort to mitigate damage to the surrounding vehicle structure and prevent injury to people in the occupant cabin of the vehicle. In addition, it is beneficial for a bumper assembly to avoid harmful damage to the other vehicle involved in a collision. For example, some vehicle impact tests that are mandated by government regulations and insurance certifications measure the resulting damage to a standardized barrier designed to mimic the other vehicle during a frontal impact collision, such as a movable progressive deformable barrier (MPDB) test or a Small Overlap Rigid Barrier (SORB) test. The results of these tests may be dependent on various vehicle components and designs, including the ability of the vehicle bumper to disperse impact deformation over specified sections of a barrier.

A common issue encountered by vehicles subjected to frontal impact tests that involve a barrier overlapping a corner of the vehicle is that the ends of the reinforcement beam often have a sharp corner that becomes more pronounced when the center of the reinforcement beam collapses inward. The sharp corner is formed by the end of the reinforcement beam, which terminates near its connection with the crush cans. This sharp corner can pierce into an impact barrier and reduce the area of the bumper assembly that effectively absorbs impact energy. Reinforcement beams have generally not been extended to address this issue due to the added mass and inability to fit such an extension in the available package space. Alternatively, corner brackets and other accessories have been developed to mount to the ends of reinforcement beam, each of which add significant cost and manufacturing complexities.

### SUMMARY

The present disclosure provides a reinforcement beam for a front vehicle bumper assembly that has discrete bends at outboard sections of the beam to allow ends of the beam to extend rearward and outward beyond its crush can connections to outboard portions of the bumper assembly that assist with dispersing impact energy during overlapping frontal impact collisions. The discrete bends provide a degree of curvature at the outboard sections of the reinforcement beam to extend the ends outward and rearward, while maintaining a relatively straight or slightly curved center section of the beam between the crush cans. In some examples, the reinforcement beam is formed with a high strength martensitic steel of at least 980 MPa, such as at least 1,500 MPa. Also, the reinforcement beam may be roll formed to have at least two hollow areas extending continuously along its length. The shape and material of the reinforcement beam together are configured to prevent a large buckling at the center section during a frontal impact, which maintains the position of outboard ends of the beam to absorb impact energy at the outboard area of the vehicle.

According to one aspect of the present disclosure, a reinforcement beam for a vehicle bumper assembly includes a metal sheet formed into a beam having at least one tubular section extending along a length of the beam. The length of the beam has a central section disposed between end sections of the beam, such that the length of the beam spans laterally across a vehicle frame. The beam also has bend sections formed between the central section and the end sections of the beam to dispose the end sections rearward from the central section relative to the vehicle frame. The end sections of the beam terminate at distal ends an extended length outboard along the length of the beam from the pair of connection features configured to attach the beam to crush cans. In some implementations, the extended length is at least 200 mm, and in some examples is greater than 150 mm and/or at least ⅙ of the length of the beam.

Implementations of the disclosure may include one or more of the following optional features. In some implementations, the beam includes two tubular sections that extend in parallel along the beam, such as at least along the central section of the beam. For example, the two tubular sections may be separated from each other along the length of the beam. In another example, the two tubular sections share a common center wall along the length of the beam.

In some implementations, the bend sections each have a bend radius of less than 1,000 mm. Also, in some implementations, the bend radius of each of the bend sections is less than half of the length of the reinforcement beam between the distal ends along the longitudinal axis of the reinforcement beam. The end sections of the beam, in some examples, include straight sections that extend to the distal ends of the beam. The straight sections may each having a length of greater than 100 mm. In some examples, the central section of the beam is straight along the length of the beam. Further, in some implementations, the bend sections of the beam have transition sections at ends of the bend sections that interface with the central and end sections of the beam. The transitions sections each having a progressively decreasing bend radius from the central section or the end section to the bend radius at the bend section, such as less than 1,000 mm. The transition sections, in some examples, have a length of at least 50 mm.

According to another aspect of the present disclosure, a vehicle bumper assembly includes a reinforcement beam and a pair of crush cans. The reinforcement beam is formed from a metal sheet and includes at least one tubular section that extends along a length of the reinforcement beam. The length of the reinforcement beam has a central section disposed between end sections with bend sections disposed between the central section and end sections. The length of the reinforcement beam is configured to span laterally across a vehicle frame with the end sections extending rearward from the central section relative to the vehicle frame. The pair of crush cans have rear portions that attach to the vehicle frame and front portions that attach to the reinforcement beam at least partially at the bend sections. The end sections of the reinforcement beam terminate at distal ends that are located rearward from the rear portions of the pair of crush cans relative to the vehicle frame.

In further implementations, the distal ends of the reinforcement beam are disposed at least 200 mm outboard along the length of the reinforcement beam from the front portions of the pair of crush cans. The pair of crush cans, in some examples, have a length between end surfaces of the front and rear portions of at least 150 mm. In some implementations, the pair of crush cans each have a tubular can portion that is attached to the reinforcement beam via a frame connection plate, where the tubular can portions extend generally longitudinally relative to the vehicle frame.

According to a further aspect of the disclosure, a vehicle bumper assembly includes a reinforcement beam that is formed from a metal sheet and has at least one tubular section extending along a length of the reinforcement beam. The length has a central section disposed between end sections with bend sections disposed between the central section and end sections. The length is configured to span laterally across a vehicle frame with the end sections extending rearward from the central section relative to the vehicle frame. A pair of crush cans have rear portions that are configured to attach to the vehicle frame and front portions that attach to a rear surface of the reinforcement beam. The end sections of the reinforcement beam terminate at distal ends of the reinforcement beam that are disposed an extended length outboard along the length of the beam from the front portions of the pair of crush cans. The extended length is at least 200 mm of the length of the reinforcement beam.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a schematic side elevation view of a vehicle having a bumper assembly.

FIG. 2 is a top plan view of a vehicle and a trolley used in an MPDB impact test.

FIG. 3 is a front elevation view of an example of a bumper assembly.

FIG. 4 is an upper perspective view of the bumper assembly shown in FIG. 3.

FIG. 5 is a front upper perspective view of the crush cans and reinforcement beam of the bumper assembly shown in FIG. 4.

FIG. 6 is a rear upper perspective view of the bumper assembly shown in FIG. 5.

FIG. 6A is a cross-sectional perspective view of the bumper assembly taken at the section line A-A shown in FIG. 6.

FIG. 6B is a cross-section view of the reinforcement beam taken at the section line B-B shown in FIG. 5.

FIG. 7 is a rear perspective view of the reinforcement beam shown in FIG. 4.

FIG. 8 is a top plan view of the crush cans and reinforcement beam of the bumper assembly shown in FIG. 4.

FIG. 9 is a side elevation view of the crush cans and reinforcement beam of the bumper assembly shown in FIG. 4.

FIG. 9A is a cross-sectional elevation view of the bumper assembly taken at the section line A-A shown in FIG. 6.

FIG. 10 is a top plan view of the reinforcement beam shown in FIG. 4.

FIG. 11 is an upper perspective view of another example of a bumper assembly.

FIG. 12 is a rear perspective view of the bumper assembly shown in FIG. 11.

FIG. 12A is a cross-sectional perspective view of the bumper assembly taken at the section line A-A shown in FIG. 12.

FIG. 12B is a cross-section view of the reinforcement beam taken at the section line B-B shown in FIG. 11.

FIG. 13 is a top plan view of the crush cans and reinforcement beam of the bumper assembly shown in FIG. 11.

FIG. 14 is a side elevation view of the crush cans and reinforcement beam of the bumper assembly shown in FIG. 11.

FIG. 14A is a cross-sectional elevation view of the bumper assembly taken at the section line A-A shown in FIG. 12.

FIG. 15 is a top plan view of the reinforcement beam shown in FIG. 11.

FIG. 16 is a front upper perspective view of a further example of a reinforcement beam.

FIG. 17 is a rear upper perspective view of the reinforcement beam shown in FIG. 16.

FIG. 17A is a cross-sectional perspective view of the bumper assembly taken at the section line A-A shown in FIG. 17.

FIG. 18 is a top plan view of the reinforcement beam shown in FIG. 16.

FIG. 19 is schematic illustration of a bending process for a reinforcement beam.

FIG. 20 is a top plan view of an example of a reinforcement beam.

FIG. 21 is a top plan view of another example of a reinforcement beam.

FIG. 22 is a top plan view of the reinforcement beam of FIG. 20 overlaying the reinforcement beam of FIG. 21.

FIG. 23 is a top plan view of a further example of a reinforcement beam.

FIG. 24 is a top plan view of the reinforcement beam shown in FIG. 21.

### DETAILED DESCRIPTION

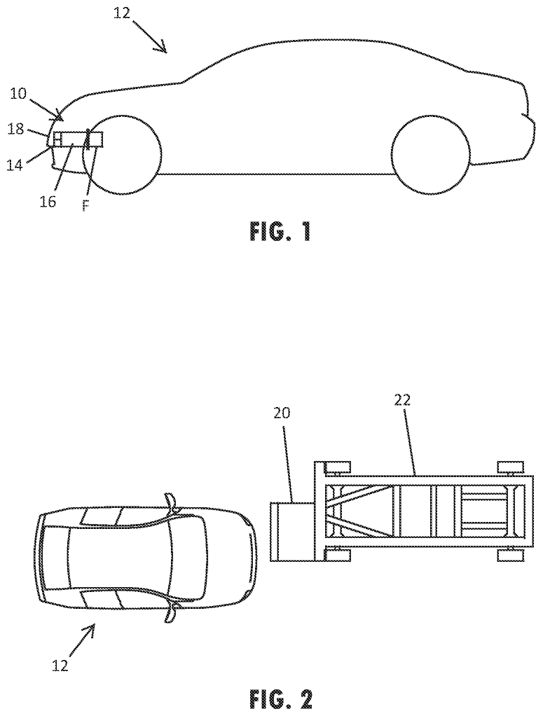

Referring now to the drawings and the illustrative examples depicted therein, a bumper assembly 10 for a vehicle 12, such as shown in FIG. 1, has a reinforcement beam 14, also referred to as a bumper beam, that is supported by crush cans 16 that are attached to the reinforcement beam 14 at generally equal spacing from a center of the reinforcement beam 14. The crush cans 16 of the bumper assembly 10 each mount to a frame member F, such as a frame rail or other portion of a conventional vehicle frame or a portion of uni-body frame or the like. The crush cans 16 support the reinforcement beam 14 to span laterally across a front end of the vehicle 12, such as illustrated in FIG. 1. As further shown in FIG. 1, the front face of the reinforcement beam 14 is disposed in the package space available behind a front fascia 18 of the vehicle 12. The bumper assembly 10 is mounted at the front end of the vehicle 12, such as a car as shown in FIG. 1 or other type of vehicle, such as a sport utility vehicle, truck, bus, van, or other type of motor vehicle.

As shown for example in FIG. 2, a mobile or movable progressive deformable barrier (MPDB) collision test includes a deformable barrier 20 that is attached to a trolley 22 directed to move toward and in general longitudinal alignment with the vehicle 12 for performing the MPDB collision test. The deformable barrier 20 is positioned to face the vehicle 12 and overlap with approximately 50% of the width of the vehicle 12, such as to overlap an outboard area of the vehicle 12. In the example shown in FIG. 2, the trolley 22 carrying the barrier 20 weighs approximately 1,400 kg and both the trolley 22 and the vehicle 12 are driven to a speed of about 50 kph immediately prior to collision. Upon impact with an object, such as the deformable barrier 20 of the MPDB collision test, the outboard portion of the bumper assembly 10 disclosed herein is configured to disperse the impact forces over the longitudinal extent of the reinforcement beam 14, which extends outboard beyond the crush cans 16 to absorb the impact forces in an improved and more homogenous deformation from traditional bumper assemblies. The longitudinal shape and steel material of the reinforcement beam 14 together prevent a large buckling at the center section during a frontal impact, which maintains the position of outboard ends of the beam to absorb impact energy at the outboard area of the vehicle.

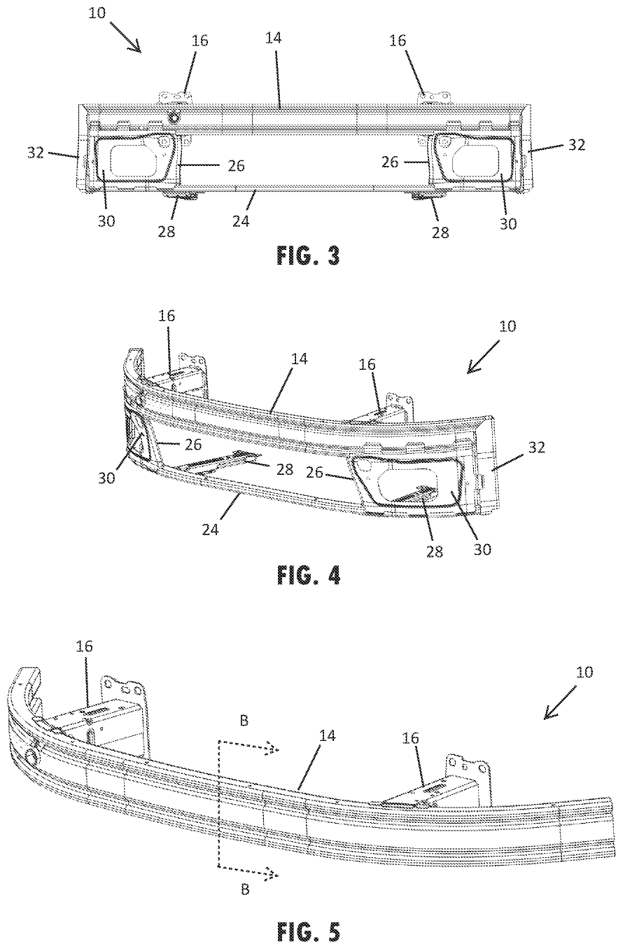

The bumper assembly 10 in some examples, such as shown in FIGS. 3 and 4, may also include a lower leg catcher beam 24 that spans laterally below the reinforcement beam 14. The lower leg catcher beam 24 may be support by brackets 26 mounted to the reinforcement beam 14 and/or by reinforcement bars 28 that extend rearward from the lower leg catcher beam 24 connect to an underbody portion of the vehicle, such as a portion of the frame. The bumper assembly 10 may also include impact dispersion plates, such as the impact dispersion plates 30 shown in FIGS. 3 and 4 connecting between the reinforcement beam 14 and the lower leg catcher beam 24 at the outboard portions of the bumper assembly 10. In addition, the bumper assembly 10 shown in FIGS. 3 and 4 includes suspender brackets 32 that connect between the distal ends of the reinforcement beam 14 and the lower leg catcher beam 24. The bumper assembly in other examples may include other brackets or reinforcements from that shown in FIGS. 3 and 4 or may otherwise omit or alter those shown, such as to conform the bumper assembly design to a particular vehicle design or package space. The lower leg catcher beam, brackets, and impact dispersion plates may be formed with various different materials and combinations of materials, such metal sheets, polymers, composites, and the like. The metals may be aluminum or steel alloys, such as a high-strength steel (e.g., a dual-phase steel) or ultra-high strength steel.

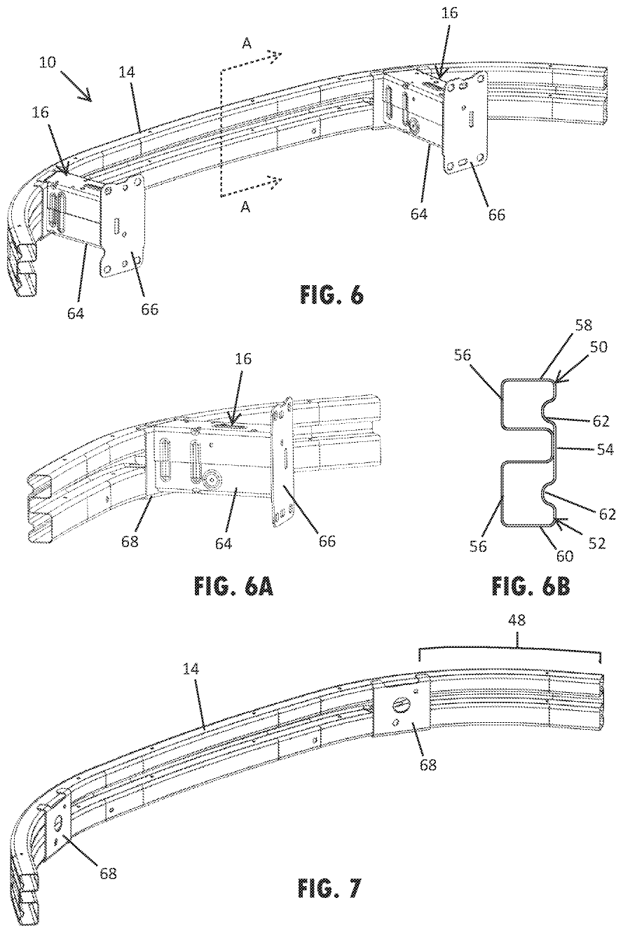

Referring now to the reinforcement beam 14 and crush cans 16 of the bumper assembly 10, such as shown in FIGS. 5 and 6, the reinforcement beam 14 has discrete bends at outboard sections, such as bend sections 36, 38 shown in FIG. 10, of the reinforcement beam 14 for the ends of the reinforcement beam 14 to extend rearward and outward beyond the connections with the crush cans 16 to the outboard portions of the bumper assembly 10 that assist with dispersing impact energy during frontal impact collisions that overlap or otherwise contact the outer or corner sections of the front end of the vehicle. The discrete bends provide a degree of curvature at the outboard sections of the reinforcement beam 14 that causes the ends to extend outward and rearward relative to the vehicle 12, while maintaining a relatively straight or slightly curved center section of the reinforcement beam 14 between the crush cans 16.

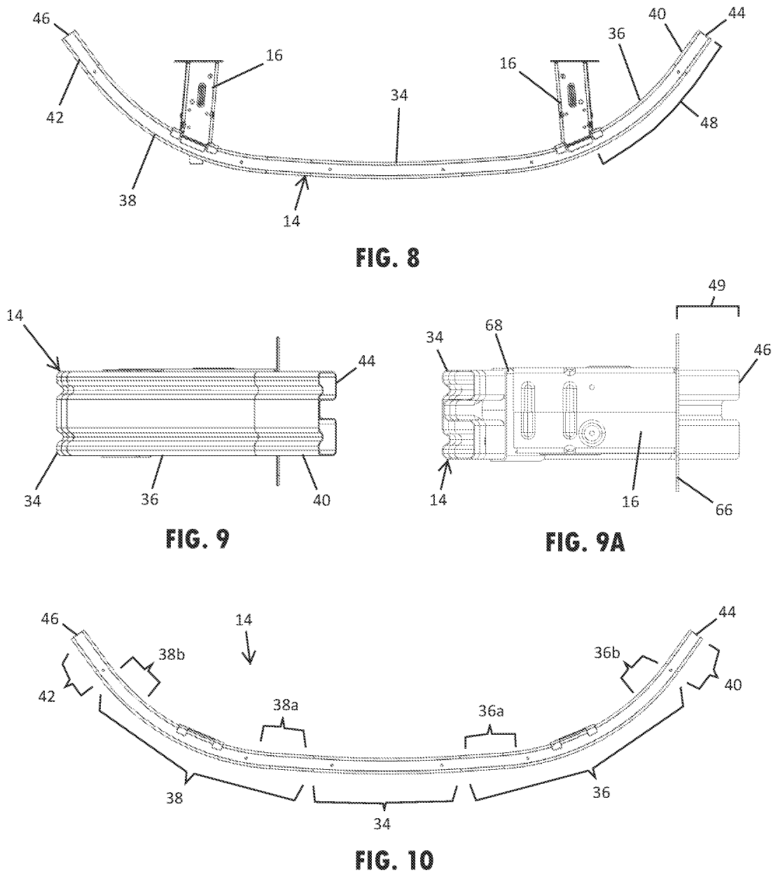

As shown in FIGS. 8 and 10, the reinforcement beam 14 has a central section 34 that is disposed between end sections 40, 42 along the length of the reinforcement beam 14. The reinforcement beam 14 also has bend sections 36, 38 disposed between the central section 34 and the end sections 40, 42 of the reinforcement beam 14 to position the end sections 40, 42 rearward from the central section 34 relative to the vehicle frame. The end sections 40, 42 of the reinforcement beam 14 terminate at distal ends 44, 46 that are an extended length outboard along the length of the reinforcement beam 14 from the connection between the beam 14 and the crush cans 16. In some examples, the extended length outboard along the length of the reinforcement beam 14 is at least 200 mm. In addition or in other examples, the extended length outboard from the connection with the crush cans 16 is at least 100 mm, at least 300 mm, and/or approximately or at least ⅛ or at least ⅙ of the overall length of the reinforcement beam 14. As shown in the example of FIGS. 7 and 8, the distal ends 44, 46 are disposed at an extended length 48 from the connection with the crush cans 16 of approximately 390 mm longitudinally along the center axis of the reinforcement beam 14. As such, the extended length may be at least 200 mm, at least 300 mm, between 300 and 500 mm, and/or between 350 and 450 mm.

As further shown in FIGS. 9 and 9A, the distal ends 44, 46 of the reinforcement beam 14 extend longitudinally rearward relative to the longitudinal extent of the vehicle frame at least a distance rearward the crush cans 16. Specifically, the distal ends 44, 46 are shown extending rearward the frame engaging plate 66 of the crush cans 16 a distance 49 of approximately 70 mm or generally greater than ⅓ of the axial length of the corresponding crush can 16, or generally greater than 50 mm. In additional examples, the rearward distance of the reinforcement beam 14 from the rear of the crush cans may be less within the scope of the disclosure, such as for bumper assemblies with crush cans that are relatively longer or that mount further outboard on the beam.

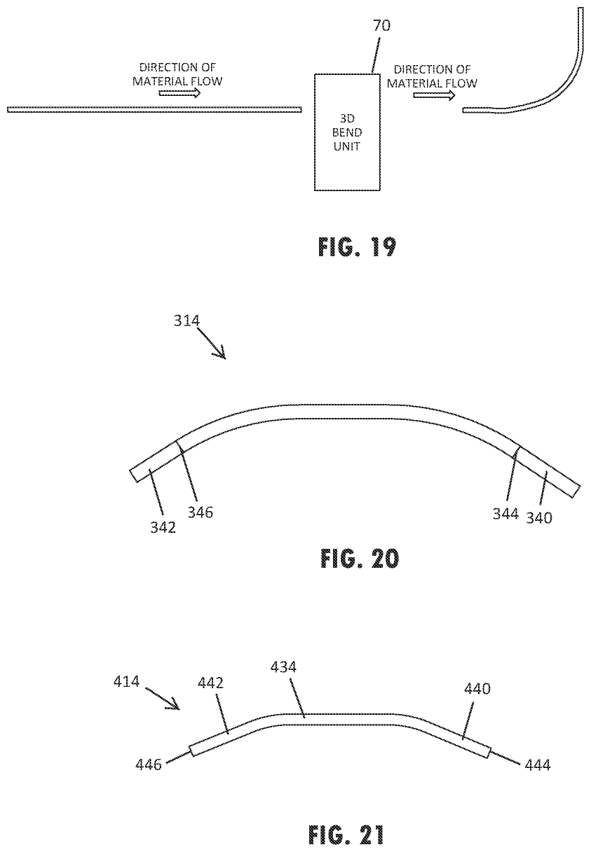

To provide the extended length of the reinforcement beam 14 rearward and outboard, the bend sections 36, 38 each have a bend radius of less than 1,000 mm, such as between 500 and 800 mm or between 450 and 600 mm. In some implementations, the bend radius of each of the bend sections 36, 38 is less than half of the length of the reinforcement beam 14 taken between the distal ends 44, 46 along the longitudinal axis of the reinforcement beam 14. Such a tight bend radius is generally not achievable with a common roll forming sweep unit placed in-line with the end of a roll former and generally not achievable with high strength martensitic steel formed in a beam cross-sectional shape or profile, such as shown in FIGS. 6-6B. To provide such a tight bend radius at each bend section, a straight beam may be placed through a 3D bend unit 70, such as shown in FIG. 19 and described further herein.

When formed with the tight bend radius, the upper and lower walls 58, 60 of the reinforcement beam 14 may include rippling disposed along the bend sections 36, 38. The rippling may be formed with the 3D bend unit 70 to provide a generally consistent wave form that extends longitudinally along the length of the beam with the wave having a shorter wavelength closer to the rear wall 56 than the front wall 54, where the wave is minimally present. The generally consistent wave form may be configured with wavelength and amplitude thresholds that do not diminish the capable impact load and energy absorption for the end sections of the beam 40, 42.

As also shown in FIGS. 8 and 10, the end sections 40, 42, of the reinforcement beam 14 include straight sections that extend to the distal ends 44, 46 of the reinforcement beam 14. The straight sections may each having a length of 100 mm or a greater length, such that the straight sections may extend the entire length of the end sections 40, 42. In some examples, the length of the straight sections may preferably be approximately 100 mm to 150 mm, or in other examples may be 80 mm to 200 mm or greater than 100 mm. Also, the central section 34 of the beam 14 may be generally straight or slightly curved, such as shown in FIGS. 8 and 10 with the central section 34 having a radius of curvature of approximately 2,800 mm. Although shown in FIGS. 8 and 10 with the end sections being linear straight sections, the end sections in additional examples may include or instead be slightly curved, such as the slight curvature of the central section. Thus, as shown in FIG. 10, the bend sections 36, 38 of the beam 14 may have transition sections 36a, 36b, 38a, 38b at ends of the bend sections 36, 38 that interface with the central section 34 and end sections 40, 42 of the reinforcement beam 14. The transitions sections 36a, 36b, 38a, 38b each having a progressively decreasing bend radius from the central section 34 or the end section 40, 42 to the bend radius at the constant curvature of the bend sections 36, 38. The transition sections may vary in length depending on the degree of curvature that is changing and whether the curvature is increase or decreasing. For example, the transition sections 36a, 36b, 38a, 38b have a length of at least 25 mm, or between 30 and 60 mm, or at least 50 mm, or approximately 50 mm.

As shown in FIGS. 6A and 6B, the reinforcement beam 14 is formed with a metal sheet, such as with a stamping, press bending, or roll forming process. The metal sheet includes a martensitic steel with a tensile strength of at least 980 MPa, and in some examples at least 1,500 MPa, such as 1,500 MPa or 1,700 MPa. The metal sheet is formed into a beam shape having at least one tubular section extending along a length of the reinforcement beam 14. The reinforcement beam 14 may also be formed to have at least two tubular sections that enclose hollow areas that extend continuously along the reinforcement beam. The metal sheet of the reinforcement beam has a thickness of about 1.4 mm, and in some examples may be approximately between 1 mm and 1.8 mm or more generally between 0.8 mm to 3.0 mm. In additional bumper assembles, the reinforcement beam may have different shapes and orientations from that illustrated and may include alternative dimensions and proportions, such as for use with different types of vehicles.

Referring again to FIGS. 5-7, the reinforcement beam 14 includes two tubular sections 50, 52 that extend in parallel and are separated from each other along the length of the beam. As shown in greater detail in FIG. 6B, the reinforcement beam 14 has upper and lower tubular sections 50, 52 that are spaced apart from each other by a portion of the front wall 54 of the reinforcement beam 14. The upper and lower tubular sections 50, 52 of the reinforcement beam 14 have rear walls 56 that are substantially vertically aligned with each other. Further, a top shear wall 58 of the upper tubular section 50 of the reinforcement beam 14 is in planar alignment with a bottom shear wall 60 of a lower tubular section 52 of the reinforcement beam 14. In additional examples, the beam may have different geometries, such as the two tubular sections sharing a common center wall along the length of the beam.

Also, the reinforcement beam may include stiffening features, such as to increase the longitudinal stiffness of the beam along its length. As shown in FIG. 6B, a stiffening channel 62 is formed in the front wall 54 of each of the tubular sections 50, 52 of the reinforcement beam 14. The stiffening channels 62 protrude into an interior volume of each tubular section 50, 52 and function to stiffen the forward-facing or impact surface of the front wall 54 of the reinforcement beam 14. The stiffening channels 62 shown in FIG. 6B include a bend radius of about 6.4 mm. In other examples, the reinforcement beam may be similarly formed with more or fewer stiffening ribs and with different bend radii.

As further shown in FIGS. 5-7, the crush cans 16 of the bumper assembly 10 may also be embodied in various configurations and materials, such as steel, aluminum, and fiber-reinforced composites, among other materials or combinations thereof. For example, as shown in FIG. 6A, the crush can 16 has a tubular can portion 64 that is attached between a frame engaging plate 66 and a front plate 68, such as via welding or other attachment means. The can portion 64 of the crush can 16 provides the side wall of the crush can, which may have a cross-section with a rounded rectangular tube shape. The central axis defined by the tubular shape of the can portion 64 may be angled slightly outward from the frame to the connection with the reinforcement beam 14, such as shown in FIG. 8. The frame engaging plate 66 of the crush can 16 has an opening that can be used for an assembly access opening or for routing a wire harnesses or the like. The peripheral portion of the frame engaging plate 66 defines a frame-side flange that is disposed at and circumscribes a rear end of the crush can 16. The frame side flange is configured to mount to a frame member F (FIG. 1), such as via fasteners that engage mounting apertures that extend through the peripheral portion of the frame engaging plate 66. It is contemplated that other fastening techniques may be used to mount the crush cans 16 to the reinforcement beam 14 and the frame member F, such as welding, adhesives, rivets, or other attachments or combinations thereof.

As shown in FIG. 7, the front plates 68 are attached to the reinforcement beam 14 and may each be considered a connection feature of the reinforcement beam 14, and in some examples may be integrated with the beam, or in other examples may be considered a portion of the crush can. In other examples, the connection features that hold the crush cans to the reinforcement beam may be various other features, such as fasteners, fastener receivers (e.g., blind rivets or spac nuts), welds, or weld alignment apertures.

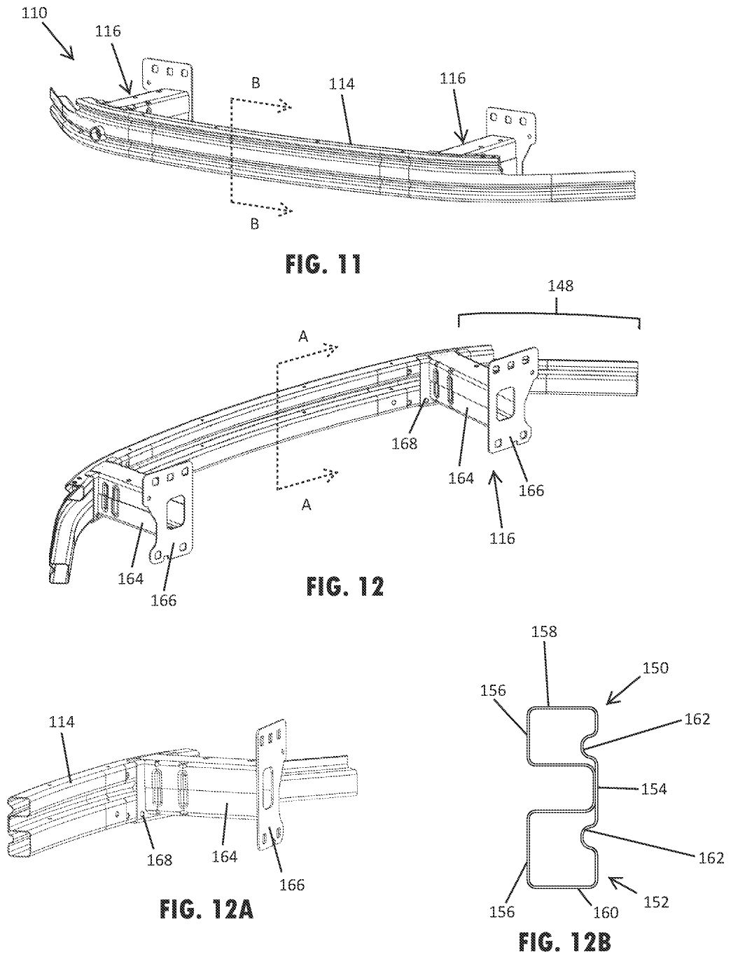

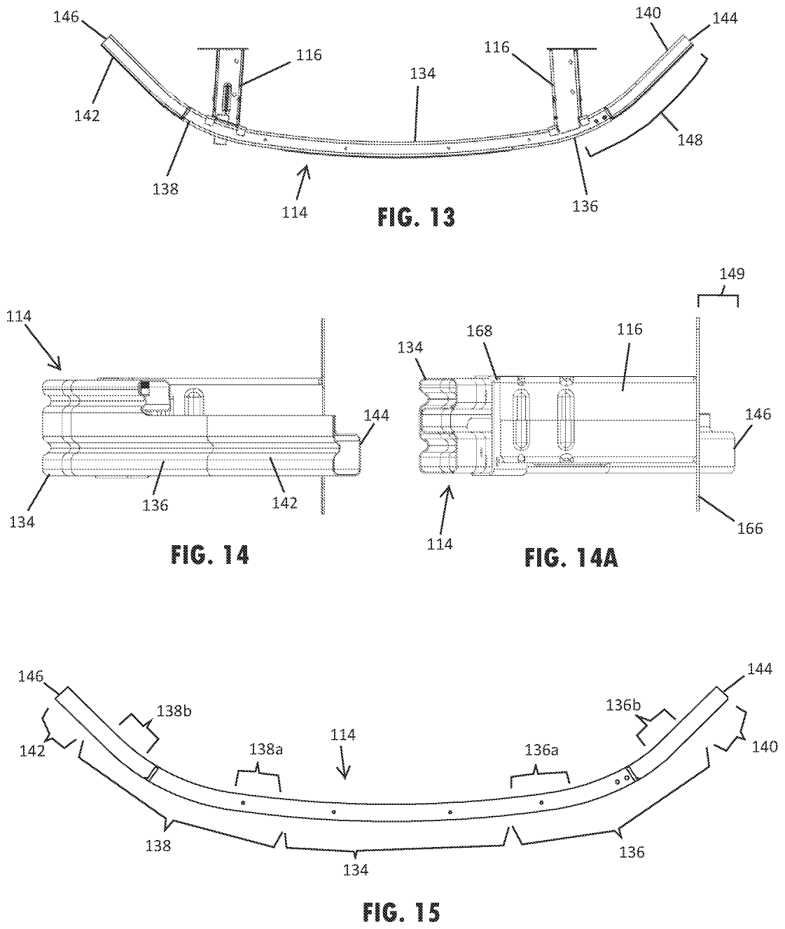

Referring now to FIGS. 11-15, an additional example of a bumper assembly 110 includes a reinforcement beam 114 that has discrete bends at outboard sections of the reinforcement beam 114 for the ends of the reinforcement beam 114 to extend rearward and outward beyond the connections with the crush cans 116 to the outboard portions of the bumper assembly 110 that assist with dispersing impact energy during frontal impact collisions that overlap or otherwise contact the outer or corner sections of the front end of the vehicle. The reinforcement beam 114 has end sections 140, 142 that terminate at distal ends 144, 146 that are an extended length outboard along the length of the reinforcement beam 114 from the connection between the beam 114 and the crush cans 116. As shown in the example of FIGS. 11-15, the distal ends 144, 146 are disposed at an extended length 148 from the connection with the crush cans 116 of approximately 300 mm longitudinally along the center axis of the reinforcement beam 114. As such, the extended length may also be at least 100 mm, at least 250 mm, between 300 and 500 mm, and/or between 250 and 450 mm. As further shown in FIGS. 14 and 14A, the distal ends 144, 146 of the reinforcement beam 114 extend longitudinally rearward relative to the longitudinal extent of the vehicle frame at least a distance rearward the crush cans 116. Specifically, the distal ends 144, 146 are shown in FIG. 14A extending rearward the frame engaging plate 166 of the crush cans 116 a distance 149 of approximately 30 mm. To provide the extended length of the reinforcement beam 114 rearward and outboard, the bend sections 136, 138 each have a bend radius of 500 mm.

Referring again to FIGS. 11-12B, the reinforcement beam 114 includes two tubular sections 150, 152 formed with a metal sheet with a tensile strength of at least 1,500 MPa that extend in parallel and are separated from each other along the beam. As shown in greater detail in FIG. 12B, the reinforcement beam 114 has upper and lower tubular sections 150, 152 that are spaced apart from each other by a portion of the front wall 154 of the reinforcement beam 114. The upper and lower tubular sections 150, 152 of the reinforcement beam 114 have rear walls 156 that are substantially vertically aligned with each other. The reinforcement beam 114 of FIGS. 11-15 includes the upper tubular section 150 cut away at the outboard sections of the reinforcement beam 114, from outboard the crush cans 116 to the distal ends 144, 146. Features of the bumper assembly 110 and associated reinforcement beam 114 and crush cans 116 shown in FIGS. 11-15 that are similar to the bumper assembly 10 and associated reinforcement beam 14 and crush cans 16 are not described in detail again, and similar reference numbers are used, incremented by 100.

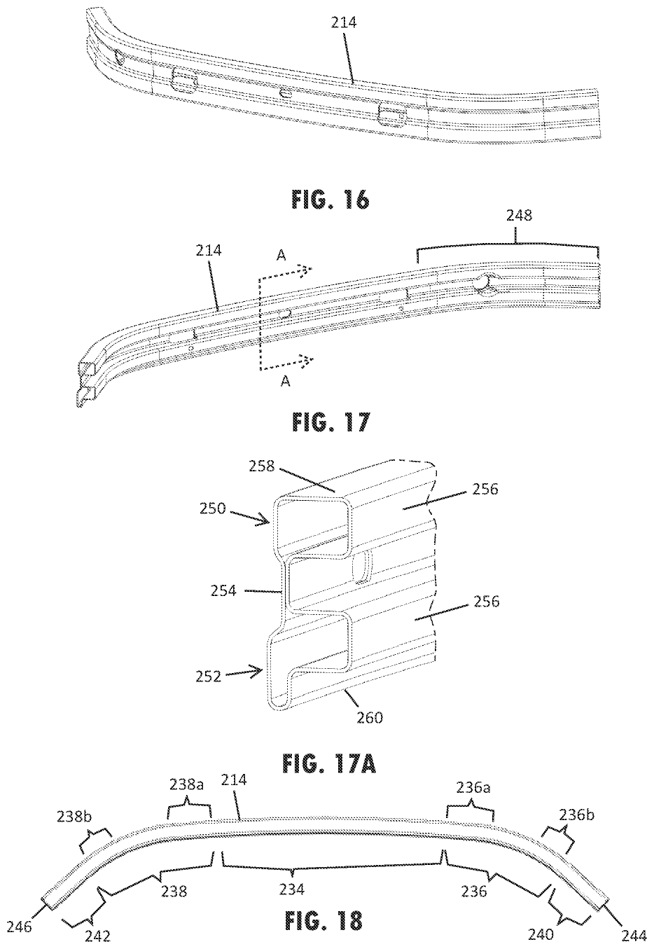

Referring now to FIGS. 16-18, a further example of a bumper assembly 210 includes a reinforcement beam 214 that also has discrete bends at outboard sections of the reinforcement beam 214 for the ends of the reinforcement beam 214 to extend rearward and outward beyond the connections with the crush cans (not shown). The reinforcement beam 214 includes two tubular sections 250, 252 formed with a metal sheet with a tensile strength of at least 1,500 MPa that extend in parallel and are separated from each other along the beam. As shown in FIG. 17A, the reinforcement beam 214 has upper and lower tubular sections 250, 252 that are spaced apart from each other by a portion of the front wall 254 of the reinforcement beam 214. The upper and lower tubular sections 250, 252 of the reinforcement beam 214 have rear walls 256 that are substantially vertically aligned with each other. The reinforcement beam 214, such as shown in FIG. 17A, has the lower tubular section 252 with a lower hollow extension to extending the beam downward and forma a relatively larger hollow area at the lower tubular section 252 than the upper tubular section 250. Features of the bumper assembly 210 and associated reinforcement beam 214 shown in FIGS. 16-18 that are similar to the bumper assembly 10 and associated reinforcement beam 14 and crush cans 16 are not described in detail again, and similar reference numbers are used, incremented by 200.

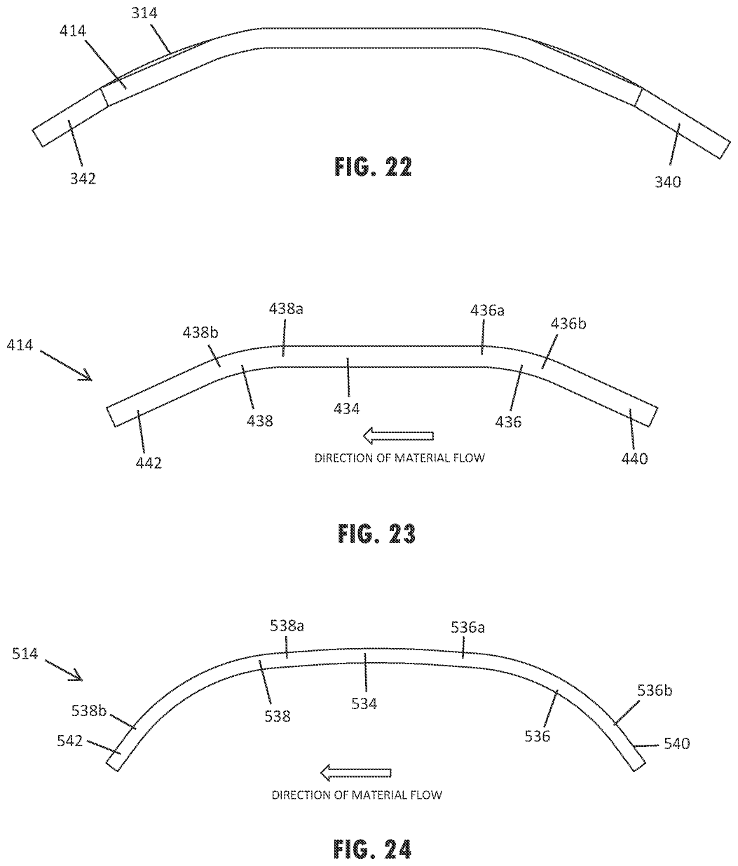

As shown in FIG. 19, the 3D bend unit 70 receives a straight roll formed stick or beam in a direction of material flow. The roll formed stick or beam is then bent by the 3D bend unit 70 to a resulting longitudinal shape of a reinforcement beam. As identified in FIG. 19, the end sections of the beam coming out of the 3D bend unit 70 are straight sections, as the 3D bend unit 70 has tolerances as to when it can begin to impart a bend radius on an inserted beam and similarly has tolerances as to when it must terminate a bend radius prior to the beam exiting the bend unit. Accordingly, because the reinforcement beam 314 shown in FIG. 20 has a longitudinal shape with a longitudinal curvature at its distal ends 344, 346, the straight end sections 340, 342 of the formed beam are cut off of the beam as scrap pieces. To avoid the resulting scrap, the reinforcement beam may be redesigned to terminate at the distal ends 444, 446 with straight end sections 440, 442, such as shown in FIG. 21. While the resulting shape of the reinforcement beam 414 in FIG. 21 is slightly different from that shown in FIG. 20, the overall longitudinal profiles are similar when overlapping, as shown in FIG. 22, such as to provide similar impact performance.

With further reference to the reinforcement beam 414 of FIGS. 21 and 23, the end sections 440, 442, of the reinforcement beam 414 include straight sections that extend to the distal ends 444, 446 with a length of 200 mm (at the end entering the bender) and 290 mm (at the end exiting the bender). Also, the central section 434 of the beam 414 is generally straight. The bend sections 436, 438 of the beam 414 have a bend radius of 500 mm and have transition sections 436a, 436b, 438a, 438b at ends of the bend sections 436, 438 that interface with the central section 434 and end sections 440, 442 of the reinforcement beam 414. In the bend unit, going from a straight section to a bend section require 50 mm and going from a bend section to a straight section requires 30 mm. For design symmetry, the transition sections 436a, 436b, 438a, 438b each have a length of 50 mm in the reinforcement beam 414 shown in FIG. 23.

Similarly, the reinforcement beam 514 of FIG. 24 has end sections 540, 542, that include straight sections that extend to the distal ends 544, 546 with a length of 200 mm (at the end entering the bender) and 290 mm (at the end exiting the bender). Also, the central section 534 of the beam 514 has a slight curvature of a 2,800 mm bend radius. The bend sections 536, 538 of the beam 514 have transition sections 536a, 536b, 538a, 538b at ends of the bend sections 536, 538 that interface with the central section 534 and end sections 540, 542 of the reinforcement beam 514. In the bend unit, going from a straight section to a bend section requires 50 mm and going from a bend section to a straight (or slightly curved) section requires 30 mm. Again, however, for design symmetry, the transition sections 536a, 536b, 538a, 538b each have a length of 50 mm in the reinforcement beam 514 shown in FIG. 24.

Features of the reinforcement beams 414 and 514 shown in FIGS. 20-24 that are similar to the reinforcement beam 14 are not described in detail again, and similar reference numbers are used, incremented by 400 and 500, respectively.

Also for purposes of this disclosure, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A reinforcement beam for a vehicle bumper assembly, the reinforcement beam comprising:
a beam comprising a metal sheet formed to define at least one tubular section extending along a length of the beam;
wherein the length of the beam comprises a central section disposed between end sections of the beam, the length of the beam configured to span laterally across a vehicle frame;
wherein the beam comprises bend sections formed between the central section and the end sections of the beam to dispose the end sections rearward from the central section relative to the vehicle frame; and
wherein the beam comprises a pair of connection features configured to attach to crush cans, the end sections of the beam terminating at distal ends of the beam that are disposed an extended length outboard along the length of the beam from the pair of connection features, and the extended length is at least 200 mm of the length of the beam.

2. The reinforcement beam of claim 1, wherein the beam comprises two tubular sections extending in parallel along at least the central section of the beam.

3. The reinforcement beam of claim 2, wherein the two tubular sections are separated from each other along the length of the beam.

4. The reinforcement beam of claim 1, wherein the bend sections each have a bend radius of less than 1,000 mm.

5. The reinforcement beam of claim 1, wherein the bend sections each have a bend radius that is less than half of the length of the reinforcement beam between the distal ends along a longitudinal axis of the reinforcement beam.

6. The reinforcement beam of claim 1, wherein the end sections of the beam comprise straight sections of the beam that extend to the distal ends, the straight sections each having a length of at least 100 mm.

7. The reinforcement beam of claim 1, wherein the central section of the beam is straight along the length of the beam.

8. The reinforcement beam of claim 1, wherein the bend sections of the beam each comprise transition sections at interfacing ends of the bend sections that interconnect with the central section of the beam, the transitions sections each having a progressively decreasing bend radius from the central section toward the bend sections.

9. The reinforcement beam of claim 8, wherein the transition sections each have a length of at least 25 mm.

10. A vehicle bumper assembly comprising:
a reinforcement beam formed from a metal sheet, the reinforcement beam comprising at least one tubular section extending along a length of the reinforcement beam, the length having a central section disposed between end sections with bend sections disposed between the central section and end sections, and the length configured to span laterally across a vehicle frame with the end sections extending rearward from the central section relative to the vehicle frame; and
a pair of crush cans having rear portions configured to attach to the vehicle frame and front portions attached to the reinforcement beam at least partially at the bend sections; and
wherein the end sections of the reinforcement beam terminate at distal ends that are located rearward from the rear portions of the pair of crush cans relative to the vehicle frame.

11. The vehicle bumper assembly of claim 10, wherein the distal ends of the reinforcement beam are disposed at least 200 mm outboard along the length of the reinforcement beam from the front portions of the pair of crush cans.

12. The vehicle bumper assembly of claim 10, wherein the reinforcement beam comprises two tubular sections extending in parallel along at least the central section of the reinforcement beam.

13. The vehicle bumper assembly of claim 12, wherein the two tubular sections are separated from each other along the length of the reinforcement beam.

14. The vehicle bumper assembly of claim 10, wherein the bend sections have a bend radius of less than 1,000 mm.

15. The vehicle bumper assembly of claim 10, wherein the end sections of the reinforcement beam comprise straight sections along the length of the reinforcement beam that extend to the distal ends, the straight sections each having a length of greater than 100 mm.

16. The vehicle bumper assembly of claim 10, wherein the central section of the reinforcement beam is straight along the length of the reinforcement beam.

17. The vehicle bumper assembly of claim 10, wherein the bend sections of the reinforcement beam each comprise transition sections that interface with the central section of the reinforcement beam, the transitions sections each having a progressively decreasing bend radius outboard from the central section.

18. The vehicle bumper assembly of claim 17, wherein the metal sheet comprises a martensitic steel with a tensile strength of at least 980 MPa.

19. The vehicle bumper assembly of claim 10, wherein the pair of crush cans each have a length between end surfaces of the front and rear portions of at least 150 mm.

20. A vehicle bumper assembly comprising:
a reinforcement beam formed from a metal sheet, the reinforcement beam comprising at least one tubular section extending along a length of the reinforcement beam, the length having a central section disposed between end sections with bend sections disposed between the central section and end sections, and the length configured to span laterally across a vehicle frame with the end sections extending rearward from the central section relative to the vehicle frame; and
a pair of crush cans having rear portions configured to attach to the vehicle frame and front portions attached to a rear surface of the reinforcement beam; and
wherein the end sections of the reinforcement beam terminate at distal ends of the reinforcement beam that are disposed an extended length outboard along the length of the beam from the front portions of the pair of crush cans, and the extended length is at least 200 mm of the length of the reinforcement beam.
